(19) United States
(12) Patent Application Publication
(10) Pub. No.: US 2009/0132707 A1
(43) Pub. Date: May 21, 2009

(54) SERVICE PROVIDING APPARATUS, CONTROL METHOD THEREOF, AND STORAGE MEDIUM

(75) Inventor: Takafumi Mizuno, Higashimurayama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/266,238

(22) Filed: Nov. 6, 2008

(30) Foreign Application Priority Data
Nov. 20, 2007 (JP) 2007-300758

(51) Int. Cl. G06F 15/173

(52) U.S. Cl. 709/226

(57) ABSTRACT

A service providing apparatus includes a receiving unit to receive a service request transmitted from other apparatus, a first determination unit to determine whether the other apparatus is an apparatus to be provided with a service by the service providing apparatus, a service providing unit to provide the service to the other apparatus when the first determination unit determines that the other apparatus is the apparatus to be provided with the service, a second determination unit to determine whether other service providing apparatus that is to provide a service to the other apparatus can provide the service when the first determination unit determines that the other apparatus is not the apparatus to be provided with the service, wherein the service providing unit provides the service to the other apparatus when the second determination unit determines that the other service providing apparatus cannot provide the service.

### BACKGROUND OF THE INVENTION

1. Field of the Invention

The present invention relates to a service providing apparatus that provides its own functions as a service, control method thereof, and a storage medium.

2. Description of the Related Art

Recent highly-functional and multifunctional image forming apparatuses connected to a network allow devices, e.g., a personal computer (PC) or other image forming apparatus, on the network to use various functions of such image forming apparatuses. Conventionally, the devices on the network mainly use optional functions that are added on the image forming apparatus in a form of hardware, e.g., a finisher that performs stapling and setting of a new paper size. However, in recent years, image formation apparatuses provide as a service its software functions to be used for another apparatus on the network. Examples of such a service are image processing that perform color conversion and format conversion of an image, and facsimile transmission via the Internet. That is, an image forming apparatus which does not include advanced functions can use such functions that are provided as a service by another image forming apparatus.

Further, functions of processors such as a central processing unit (CPU) that perform processes inside the image forming apparatus have improved. Processes that have been conventionally performed by a dedicated semiconductor chip can be stored as software inside the image forming apparatus. Such software can be executed by a general-purpose CPU to perform the processes. For example, the dedicated semiconductor chip conventionally performed a high-speed image processing for format conversion. However, in recent years, the format conversion process can be stored inside the image forming apparatus as software, and performed by the general-purpose CPU.

Such software can be embedded as firmware, or stored in a flash memory or a hard disk inside the image forming apparatus as additional application software. Consequently, functions can be improved and newly added by upgrading a version of the firmware or the software, or additionally installing the firmware or the software.

When a plurality of image forming apparatuses is connected to a network, versions of firmware or software in all devices may not be collectively upgraded. Such a case occurs when a user desires to upgrade a version of a limited number of the firmware or the software to confirm whether the firmware or the software can be stably executed before changing an entire environment in operation. That is, the user upgrades the firmware or the software in one device or only a portion of devices, and then upgrades those in all of the devices after a given period has elapsed.

Further, in a case where a new function to be added is a fee-based function, a user may temporarily add the new function to only one portion of devices and later add the function to other devices.

As described above, when there is the plurality of image forming apparatuses on the network, differences in functional abilities among the devices are generated by upgrading or additionally installing the firmware or the software. In such a case, users tend to use a device with an advanced function, and intensively access a specific device that provides the advanced function as a service. Therefore, it is necessary to distribute a load to the plurality of devices so that the load is not centralized on the specific device.

An example will be described with reference to FIG. 5. Image forming apparatuses 501, 502, and 503 each provides a service. Hereinafter, an image forming apparatus that provides its own function as a service will be referred to as a service providing apparatus. Image forming apparatuses 504, 505, 506, 507, 508, and 509 each includes limited functions and use a service provided by the service providing apparatus. Hereinafter, an image forming apparatus that use a service provided by a service providing apparatus will be referred to as a service using apparatus. FIG. 5 illustrates an image forming system in which the image forming apparatuses 501, 502, 503, 504, 505, 506, 507, 508, and 509 are communicably connected to each other via a network.

Generally, a service providing apparatus is grouped together with a service using apparatus that uses a service. The service providing apparatus and the service using apparatus that are physically close to each other are often grouped together, since a user uses the service providing apparatus to print and needs to fetch a printout from the service providing apparatus. Further, the apparatuses are grouped to distribute a load. Referring to FIG. 5, a group 510 includes the service providing apparatus 501 and the service using apparatuses 504 and 505. A group 511 includes the service providing apparatus 502 and the service using apparatuses 506 and 507. A group 512 includes the service providing apparatus 503 and the service using apparatuses 508 and 509. Hereinafter, configurations that are similar to those illustrated in FIG. 5 will be allocated the same numeral.

In the image forming system illustrated in FIG. 5, the service providing apparatuses 501, 502, and 503 use version 1.0 firmware or software. Version 1.0 indicates that the service providing apparatus can provide a function of converting an image read by a scanner into a portable document format (PDF) as a service. In such a case, each service using apparatus uses a function of the service providing apparatus within the respective group.

Referring to FIG. 6, the firmware or the software used in the service providing apparatus 501 of the image forming system is upgraded to version 2.0. The version 2.0 firmware or software can create an encrypted PDF. If a user of the service using apparatus 506 included in the group 511 wants to create an encrypted PDF, the user connects to the service providing apparatus 501 that provides the encrypted PDF function as a service (i.e., communication 601 in FIG. 6). More specifically, the user will use a service providing apparatus other than the service providing apparatus 502 which is normally used by the service using apparatus 506.

Further, FIG. 7 illustrates the image forming system in which the version of the firmware (or software) of the service providing apparatus 502 that is an original connecting destination of the service using apparatus 506 is upgraded to the version 2.0. Consequently, the user can then use the encrypted PDF function provided by the service providing apparatus 502. However, if the user of the service using apparatus 506 may not notice that the software in the service providing apparatus 502 has been upgraded, the user continues to use the service providing apparatus 501 (i.e., communication 701 illustrated in FIG. 7). As a result, a load is centralized on one image forming apparatus.

In order to solve such a problem, Japanese Patent Application Laid-Open No. 2002-7749 discusses a server sorting apparatus that distributes a load on an image forming apparatus. The server sorting apparatus receives all connections and selects a service providing server based on a service usage result of a service user.

However, the technology discussed in Japanese Patent Application Laid-Open No. 2002-7749 requires a separate management server other than a service providing apparatus. Further, a user cannot purposely use an apparatus that includes an advanced function in a case where there is a functional difference in services among apparatuses. More specifically, the technology discussed in Japanese Patent Application Laid-Open No. 2002-7749 cannot perform control which allows a user to temporarily use a specific apparatus until there is no functional difference among apparatuses, and then return to an original connection destination.

### SUMMARY OF THE INVENTION

The present invention is directed to preventing intensive access to a specific service providing apparatus in a case where there is a plurality of service providing apparatuses that each provides a service. Further, the present invention is directed to allowing a service using apparatus to temporarily use a service providing apparatus in a case where there is a specific service only provided by the service providing apparatus.

According to an aspect of the present invention, a service providing apparatus is provided that includes a receiving unit adapted to receive a service request transmitted from other apparatus, a first determination unit adapted to determine whether the other apparatus is an apparatus to be provided with a service by the service providing apparatus, a service providing unit adapted to provide the service to the other apparatus in a case where the first determination unit determines that the other apparatus is the apparatus to be provided with the service, and a second determination unit adapted to determine whether other service providing apparatus that is to provide a service to the other apparatus can provide the service in a case where the first determination unit does not determine that the other apparatus is the apparatus to be provided with the service, wherein the service providing unit provides the service to the other apparatus in a case where the second determination unit does not determine that the other service providing apparatus can provide the service and does not provide the service to the other apparatus in a case where the second determination unit determines that the other service providing apparatus can provide the service.

According to another aspect of the present invention, a method is provided for controlling a service providing apparatus including, receiving a service request transmitted from other apparatus, determining whether the other apparatus is an apparatus to be provided with a service by the service providing apparatus, providing the service to the other apparatus in a case where it is determined that the other apparatus is the apparatus to be provided with the service, determining whether other service providing apparatus that is to provide a service to the other apparatus can provide the service in a case where it is not determined that the other apparatus is the apparatus to be provided with the service, and providing the service to the other apparatus in a case where it is not determined that the other service providing apparatus can provide the service and not providing the service to the other apparatus in a case where it is determined that the other service providing apparatus can provide the service.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an overall configuration of an image forming system according to an exemplary embodiment of the present invention.

FIG. 2 illustrates an overall configuration of an image forming apparatus according to an exemplary embodiment of the present invention.

FIG. 3 illustrates an external view of an input/output device in an image forming apparatus according to an exemplary embodiment of the present invention.

FIG. 4 illustrates an external view of a display unit in an image forming apparatus according to an exemplary embodiment of the present invention.

FIG. 5 illustrates an example of an operation of a grouped image forming system.

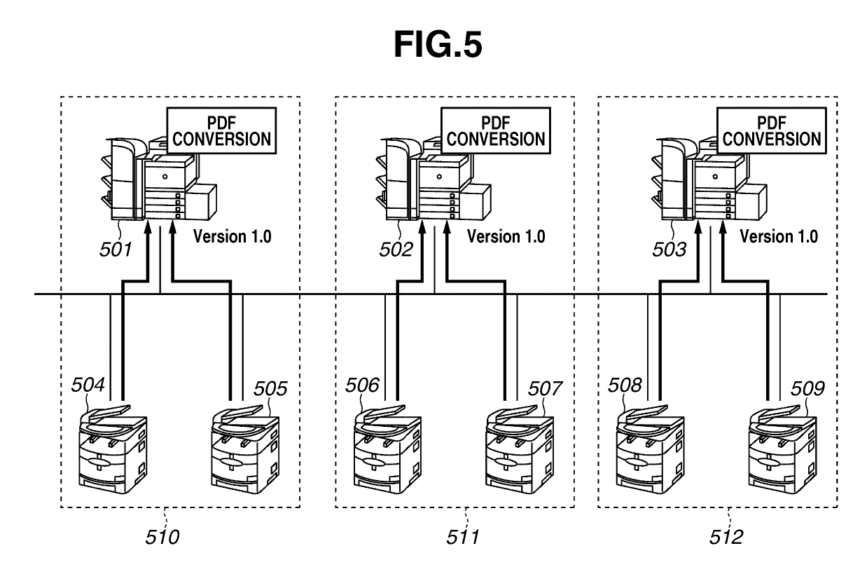

FIG. 6 illustrates an example of an operation of a grouped image forming system.

FIG. 7 illustrates an example of an operation of a grouped image forming system.

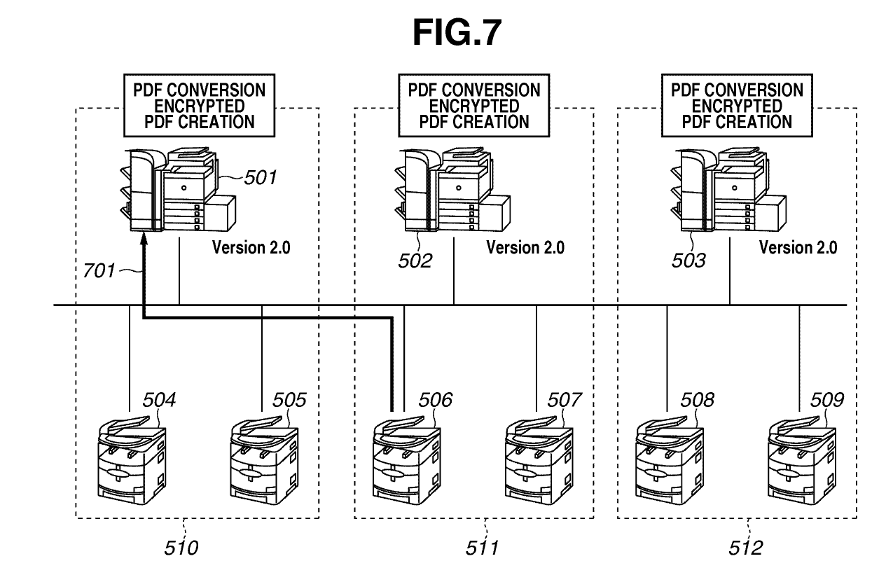

FIG. 8 illustrates an example of an operation of a grouped image forming system.

FIG. 9 illustrates an example of an operation of a grouped image forming system.

FIG. 10 illustrates an example of an operation of a grouped image forming system.

FIG. 11 illustrates an example of a table for setting a notifying address when a version is upgraded according to an exemplary embodiment of the present invention.

FIG. 12 illustrates an example of a description in a connection log managed by a service providing apparatus according to an exemplary embodiment of the present invention.

FIG. 13 illustrates an example of a description in a connection log managed by a service providing apparatus according to an exemplary embodiment of the present invention.

FIG. 14 illustrates an example of a description in a connection log managed by a service providing apparatus according to an exemplary embodiment of the present invention.

FIG. 15 is a flowchart illustrating an operation of a service providing apparatus according to an exemplary embodiment of the present invention.

FIG. 16 is a flowchart illustrating an operation of a service providing apparatus according to an exemplary embodiment of the present invention.

FIG. 17 illustrates an example of an operation of a grouped image forming system.

FIG. 18 illustrates an example of a table for setting a notifying address when a version is upgraded according to an exemplary embodiment of the present invention.

FIG. 19 is a flowchart illustrating an operation of a service providing apparatus according to an exemplary embodiment of the present invention.

FIG. 20 is a flowchart illustrating an operation of a service providing apparatus according to an exemplary embodiment of the present invention.

### DETAILED DESCRIPTION OF THE EMBODIMENTS

Various exemplary embodiments, features, and aspects of the invention will be described in detail below with reference to the drawings.

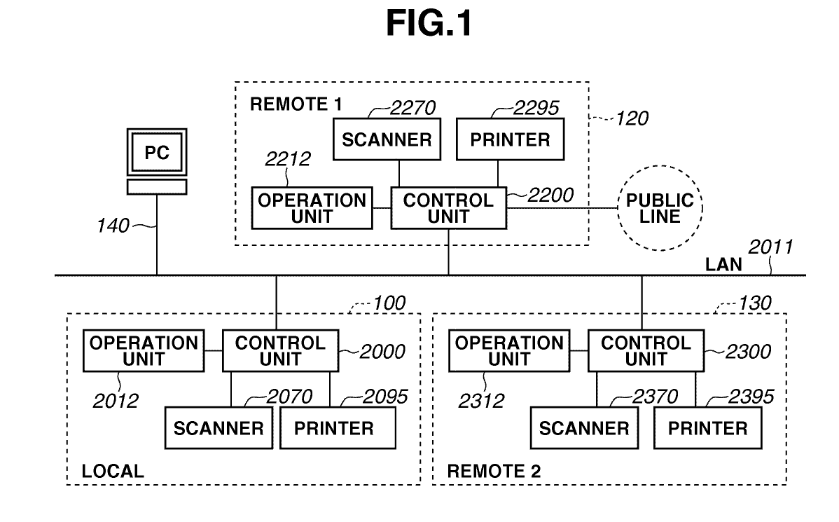

FIG. 1 illustrates a block diagram of an overall configuration of an image forming system according to a first exemplary embodiment of the present invention.

An image forming apparatus 100 includes a scanner 2070 as an image input device, a printer 2095 as an image output device, a control unit 2000, and an operation unit 2012 as a user interface. The scanner 2070, the printer 2095, and the operation unit 2012 are each connected to the control unit 2000. The control unit 2000 is connected to a network transmission unit such as a local area network (LAN) 2011, or a public line, and data such as a color image can be transmitted by a G3 or a G4 facsimile via the public line.

Other image forming apparatuses 120 and 130 that are similarly configured as the image forming apparatus 100 are connected to the LAN 2011. A personal computer (PC) 140 is also connected to the LAN 2011, and can transmit and receive an e-mail and files using a file transfer protocol (FTP) and a server message block (SMB) protocol. The image forming apparatus 120 includes a scanner 2270, a printer 2295, and an operation unit 2212 which are connected to a control unit 2200. The image forming apparatus 130 includes a scanner 2370, a printer 2395, and an operation unit 2312 which are connected to a control unit 2300.

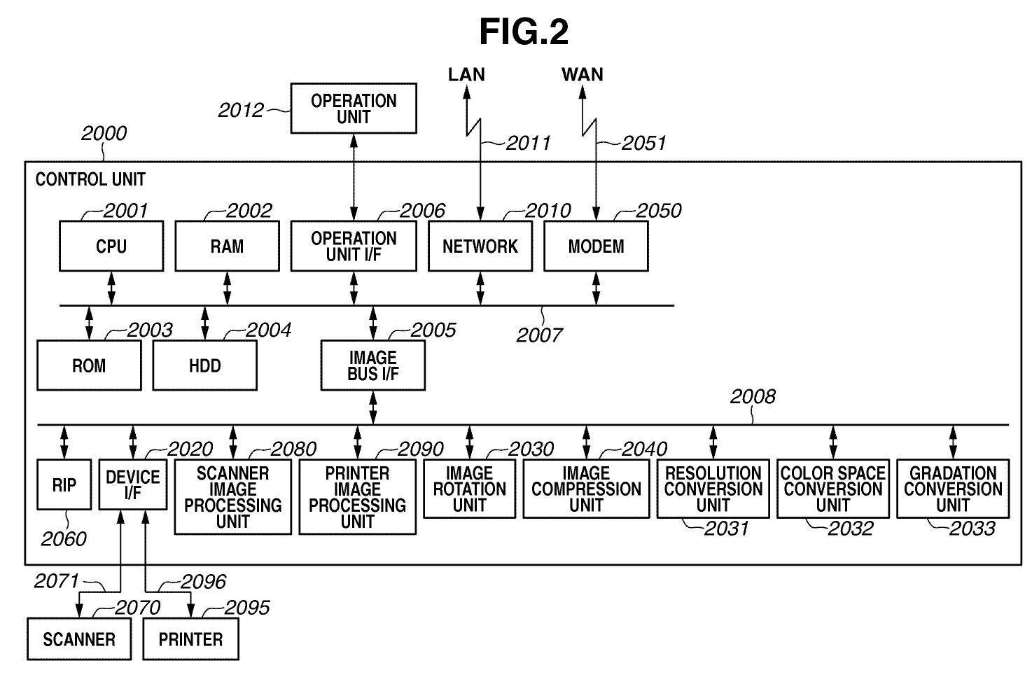

FIG. 2 illustrates a block diagram of a configuration of the image forming apparatus.

The control unit 2000 is a controller that controls input and output of image information or device information. The control unit 2000 is connected to the scanner 2070 (i.e., an image input device) and the printer 2095 (i.e., an image output device). Further, the control unit 2000 is connected to the LAN 2011 and a public line (wide area network (WAN)) 2051.

A CPU 2001 is a controller that controls an entire system.

A random access memory (RAM) 2002 is a system work memory on which the CPU 2001 operates on, and an image memory for temporarily storing image data. Further, the RAM 2002 can be provided for executing programs such as an operating system, system software, and application software.

A read-only memory (ROM) 2003 is a boot ROM and stores a boot program of the system. Further, the ROM 2003 can store a system program and an application program.

A hard disk drive (HDD) 2004 stores system software, application software, and image data. Further, the HDD 2004 can store general data files, such as data for image management, other than images and data managed by the image forming apparatus. An example of the data managed by the image forming apparatus is a connection log which records a user of a function, and when and which function was used.

An operation unit interface (I/F) 2006 is an interface unit of an operation unit (a user interface) 2012 and outputs image data to be displayed on the operation unit 2012 to the operation unit 2012. Further, the operation unit I/F 2006 transmits information that a user of the image forming system inputs via the operation unit 2012 to the CPU 2001.

A network 2010 connects to LAN 2011 and inputs and outputs information. A modem 2050 connects to the public line (WAN) 2051 and inputs and outputs image information.

The above-described devices are arranged on a system bus 2007.

An image bus I/F 2005 connects the system bus 2007 to an image bus 2008 that transfers image data at high speed. The image bus I/F 2005 is a bus bridge which converts a data structure.

The image bus 2008 is configured by a protocol control information (PCI) bus. The devices described below are connected to the image bus 2008.

A raster image processor (RIP) 2060 rasterizes a page-description language (PDL) code into a bit map image.

A device I/F 2020 connects the scanner 2070 and the printer 2095 (i.e., image input/output devices) to the control unit 2000 and performs synchronous and asynchronous transformation of image data.

A scanner image processing unit 2080 corrects, processes, and edits input image data. Further, the scanner image processing unit 2080 determines whether an input image is a color image or a monochrome image based on a chroma signal of the image, and stores the result. A printer image processing unit 2090 corrects, processes and edits output image data.

An image rotation unit 2030 works together with the scanner image processing unit 2080 to rotate the image while a scanner 2070 scans the image and stores the rotated image in a memory. Further, the image rotation unit 2030 rotates an image stored in the memory and stores the rotated image in the memory, or rotates the image stored in the memory while printing out the image by working together with the printer image processing unit 2090.

A resolution conversion unit 2031 converts a resolution of the image stored in the memory and stores the converted image in the memory.

A color space conversion unit 2032 uses matrix calculation to convert, for example, a YUV image stored in the memory into a Lab image and stores the converted image in the memory.

A gradation conversion unit 2033 converts, for example, an 8-bit color image with 256 gradations into a 1-bit monochrome image stored in the memory by an error diffusion method, and stores the converted image in the memory.

An image compression unit 2040 compresses and decompresses multivalued image data using joint photographic experts group (JPEG) compression. Further, the image compression unit 2040 compresses and decompresses a binary image data using joint bi-level image experts group (JBIG) compression, modified modified read (MMR) compression, modified read (MR) compression, and modified Huffman (MH) compression.

The image rotation unit 2030, the resolution conversion unit 2031, the color space conversion unit 2032, the gradation conversion unit 2033, and the image compression unit 2040 can jointly operate with each other. Therefore, the image in the memory can be rotated and a resolution can be converted without using the memory.

The above-described image processing such as image rotation is performed by the device connected to the image bus 2008. However, the CPU 2001 can execute such image processing by storing image processing software in the HDD 2004 and the ROM 2003 and reading the software into the RAM 2002. The software to be executed is not limited to the image processing and other software can be used to perform other processing that is required in the image forming apparatus. Further, a program stored in the ROM 2003 can be executed without being read by the RAM 2002.

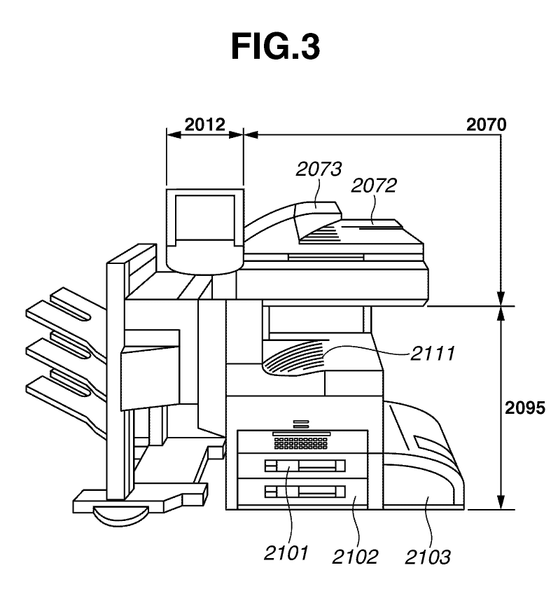

FIG. 3 illustrates an external view of the image forming apparatus.

Referring to FIG. 3, a user of the image forming apparatus sets an original document on a tray 2073 of a document feeder 2072 of the scanner 2070 (i.e., the image input device). When the user instructs the image forming apparatus to start reading the original document via the operation unit 2012, the CPU 2001 (refer to FIG. 2) gives an instruction 2071 (as indicated by a two-headed arrow illustrated in FIG. 2) to the scanner 2070. The document feeder 2072 then feeds the original document page by page to start reading of an image on the original document.

Upon receiving the instruction from the CPU 2001, the scanner 2070 illuminates the image on the original document and scans the image using a charge-coupled device (CCD) line sensor (not illustrated). The scanner 2070 converts the image into an electric signal in a form of raster image data 2071 which is transmitted to the control unit 2000.

The printer 2095 (i.e., the image output device) converts a raster image data 2096 (as indicated by a two-headed arrow 2096 illustrated FIG. 2) into an image on paper. The printer 2095 can convert the data by an electrophotographic method that uses a photosensitive drum and a photosensitive belt. The printer 2095 can also use an inkjet method in which ink is ejected from a microscopic nozzle array to directly print the image on the paper.

The CPU 2001 gives an instruction 2096 to the printer 2095 to start printing. The printer 2095 includes a plurality of paper feed trays so that different paper sizes or a direction of paper can be selected by a user. Further, the printer 2095 includes paper cassettes 2101, 2102, and 2103 that correspond to the plurality of paper feed trays. A discharge tray 2111 receives printed paper.

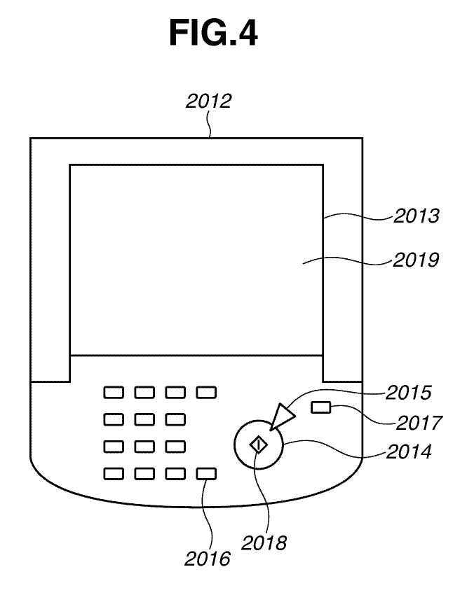

FIG. 4 illustrates a configuration of the operation unit 2012 of the image forming apparatus.

A touch panel sheet 2019 is placed on a liquid crystal display (LCD) unit 2013 that displays an operation screen of the image forming system and soft keys. When a user presses a key that is displayed on the LCD unit 2013, the touch panel sheet 2019 transmits position information of the key to the CPU 2001.

A start key 2014 is pressed to start reading of the image on the original document. Two color light-emitting diodes 2018 of red and green are disposed at the center of the start key 2014. Red or green indicates whether the start key can be used.

A stop key 2015 is pressed to stop an operation in progress.

An identification data key 2016 is pressed to input a user ID.

A reset key 2017 is pressed to initialize a setting that is input from the operation unit 2012.

The configuration of the image forming apparatus is not limited to the configuration illustrated in FIGS. 2, 3, and 4, as long as the configuration fulfills the requirements of the present invention.

A version upgrading of firmware and software which is performed to improve the performance of the image forming apparatus or to add a function to the image forming apparatus will be described below.

In the present exemplary embodiment of the present invention, firmware and software are both programs for realizing functions and are regarded as synonymous. Hereinafter, such programs will be referred to as software. However, such programs can also be referred to as firmware.

The ROM 2003 and the HDD 2004 illustrated in FIG. 2 store the software to be upgraded. In the present invention, the ROM 2003 is an electronically erasable and programmable read only memory (EEPROM). The image forming apparatus receives an upgraded version of the software from an external server connected to the network 2010 and a device connected to an external connection I/F (not illustrated). The image forming apparatus then writes over the software stored in the ROM 2003 and the HDD 2004 and updates the software. Further, new software can be added when a function is to be added to the image forming apparatus.

A service providing apparatus according to the present exemplary embodiment will be described below.

The service providing apparatus is an apparatus which provides its own functions to other devices as a service. The service providing apparatus can include an image forming apparatus, e.g., a multifunction peripheral (MFP) or a printer, and an information processing apparatus, e.g., a personal computer (PC). In the present exemplary embodiment, the service providing apparatus is an image forming apparatus. However, the service providing apparatus can be an information processing apparatus, e.g., a PC.

The service providing apparatus receives a request for providing a service via a network. The request can be received using a technology such as a Web Service, or an original protocol.

A service is a function of the service providing apparatus that can be provided to an external device, among functions which the apparatus has. The service can be provided in a form of software or hardware. An image processing function such as a PDF conversion, a facsimile transmitting/receiving function, a stapling function, and both-side printing function are the service. Hereinafter, a version of the function is synonymous to a version of the service and to a version of the software included in the service providing apparatus.

When the service providing apparatus provides the service to another device, the service providing apparatus records identification information that specifies a service using apparatus that used the service, and a date and time of use, in the connection log for each service.

The service using apparatus is an apparatus which uses the service provided by the service providing apparatus. The service using apparatus includes an image forming apparatus, e.g., a MFP or a printer, and an information processing apparatus, e.g., a PC. In the present exemplary embodiment, the service using apparatus is an image forming apparatus. However, the service using apparatus can be an information processing apparatus e.g., a PC.

The identification information that specifies the service using apparatus can be an internet protocol (IP) address and a media access control (MAC) address. Items that are recorded in the connection log are not limited to the above-described items, and other items as described below can be included.

When the service providing apparatus receives a request from the service using apparatus to use a specific service, the service providing apparatus confirms its own connection log of the service. The service providing apparatus determines whether the service using apparatus has previously used the service.

If the service using apparatus has not previously used the service, the service providing apparatus makes an inquiry to other service providing apparatuses on the network using a broadcast method. More specifically, the service providing apparatus inquires about identification information of the service using apparatus and whether the service using apparatus has used the service. The inquiry method is not limited to the broadcasting and can be any other method, such as inquiring a predetermined device, as long as the inquiry is possible.

As a result of the inquiry, if there is other service providing apparatus on the network that has provided the service to the service using apparatus, the service providing apparatus compares the versions of the services. If the version of the service provided by the other service providing apparatus is lower than that of the service providing apparatus, the service providing apparatus provides the service to the service using apparatus. On the other hand, if the version of the service provided by the other service providing apparatus is equal to or higher than that of the service providing apparatus, the service providing apparatus causes the service using apparatus to use the other service providing apparatus. Details of the process will be described below.

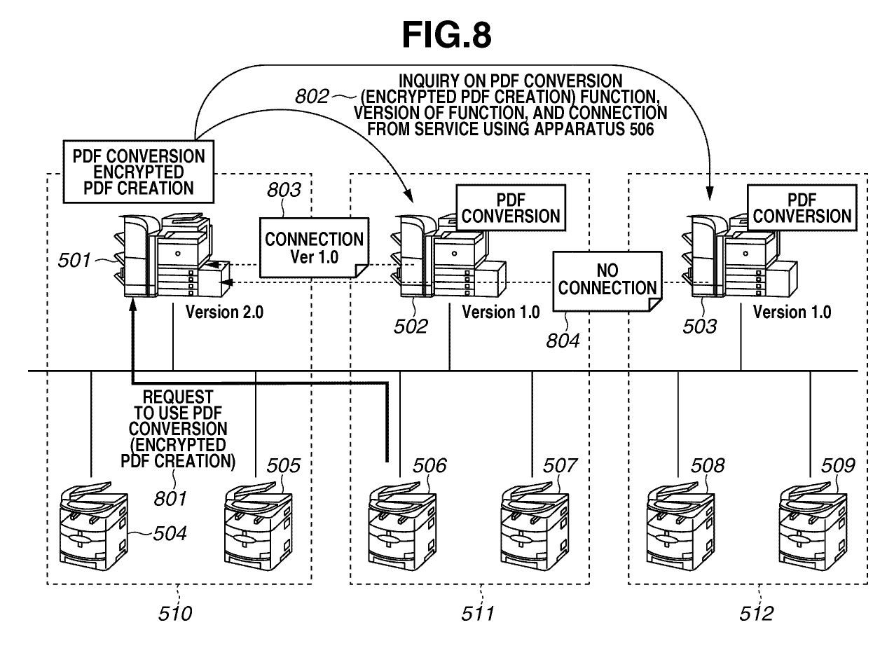

An example of the service using apparatus that uses a function of the service providing apparatus in another group will be described below with reference to FIG. 8. FIG. 8 illustrates a case where the service using apparatus 506 uses a function of the service providing apparatus 501 which is provided as a service.

Referring to FIG. 8, the service using apparatus 506 designates the service that the service using apparatus 506 desires to use and requests the service providing apparatus 501 to execute the service, as indicated by communication 801. Upon receiving the request, the service providing apparatus 501 acquires a media access control (MAC) address assigned to a network card as identification information for identifying the service using apparatus 506. The identification information is not limited to the MAC address and can be other information as long as a service using apparatus can be uniquely identified.

The service providing apparatus 501 confirms a connection log of the service and determines whether the service providing apparatus 501 has previously been connected to the MAC address of the service using apparatus 506. If the service providing apparatus 501 has been connected, the service providing apparatus 501 determines the service using apparatus 506 as a device within the group and allows the service using apparatus 506 to use the requested service. The service providing apparatus 501 then records the identification information and the date and time of use of the service using apparatus 506 in the connection log of the service as information of a normal use.

FIG. 8 illustrates an example in which the service providing apparatus 501 receives the request to use the service from the service using apparatus 506. However, the service providing apparatus 501 also operates similarly when other service using apparatus requests a service. For example, when the service using apparatus 504 which has previously connected to the service providing apparatus 501 requests the service, the service providing apparatus 501 records identification information and date and time of use of the service using apparatus 504 in the connection log of the service provided by the service providing apparatus 501 as information of a normal use.

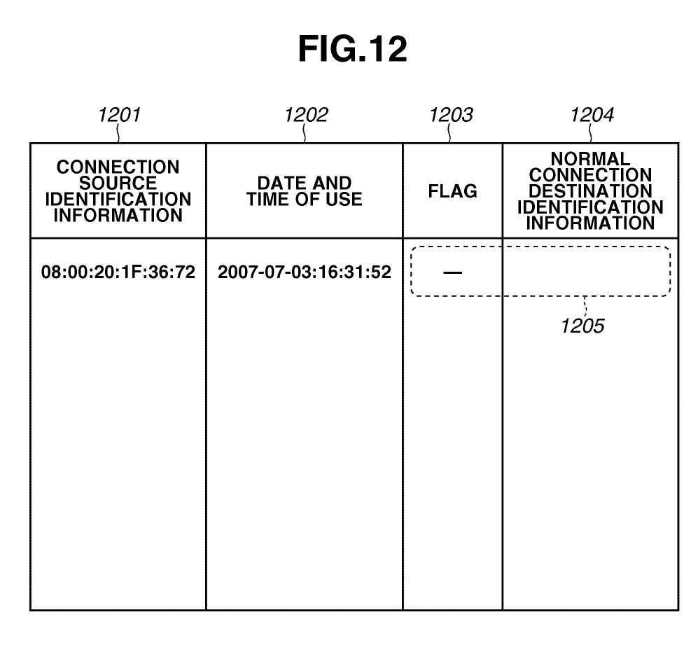

FIG. 12 illustrates an example of a description in the connection log of the above-described service. Contents to be recorded in the connection log illustrated in FIG. 12 are an example and not limited to them.

Referring to FIG. 12, connection source identification information 1201 is information for identifying a connecting source device (i.e., service using apparatus) that used the service. In the example illustrated in FIG. 12, a MAC address is described as the connection source identification information 1201. Hereinafter the MAC address is regarded as the connection source identification information. Date and time of use 1202 describes the date and time when the service has been used. A flag 1203 distinguishes whether the use of the service is temporary, as will be described below. Normal connection destination identification information 1204 is identification information about a service providing apparatus that is normally used by a service using apparatus represented by the connection source identification information 1201.

In the example illustrated in FIG. 12, a service using apparatus within a group has accessed a service providing apparatus, and since the service using apparatus has previously used the service, it is not a temporary use. Therefore, the flag 1203 is set “off (−)” and the normal connection destination identification information 1204 is blank (refer to marked area 1205).

In the present exemplary embodiment, there is a connection log for each service provided by a service providing apparatus. However, it is not limited to the present exemplary embodiment. The connection log can be in any form as long as the following information can be acquired. That is, a service that is used, identification information that can identify a service using apparatus, date and time the service was used, a flag for determining whether the service is temporarily used, and identification information about a normal service providing apparatus that should be used. For example, a connection log may record all connections and include an item to describe information which can identify a service. Alternatively, a flag can be designed to indicate whether a service is temporarily used by including or not including identification information of a normal service providing apparatus that is normally used.

Referring to FIG. 8, the service providing apparatus 501 confirms the connection log with respect to the service requested by the service using apparatus 506. As a result, if the MAC address of the service using apparatus 506 is not included in the connection log of the service, the service providing apparatus 501 determines that the service providing apparatus 501 has not been previously connected to the service using apparatus 506. The service providing apparatus 501 then inquires other service providing apparatuses on the network whether the service using apparatus 506 has previously used the service (refer to communication 802).

The service providing apparatuses 502 and 503 that received the inquiry confirm a connection log of the service thereof. More specifically, each of the service providing apparatuses 502 and 503 determines whether the MAC address of the service using apparatus 506 is included in the connection log of the service. The service providing apparatuses 502 and 503 then transmit determination results to the service providing apparatus 501. The service providing apparatuses 502 and 503 also transmit the following information to the service providing apparatus 501. That is, identification information such as a MAC address and an IP address of a service providing apparatus that returned a response, information about whether there has been a connection with respect to the service, and a version of the service.

Referring to FIG. 8, the service providing apparatus 502 replies that the service providing apparatus 502 has been connected to the service using apparatus 506, and the version of the service is 1.0 (refer to communication 803). Further, the service providing apparatus 503 replies that there has been no connection from the service using apparatus 506 (refer to communication 804).

A case will be described below where a plurality of service providing apparatuses reply that a service using apparatus has used the service when a service providing apparatus inquires whether the service using apparatus has used the service.

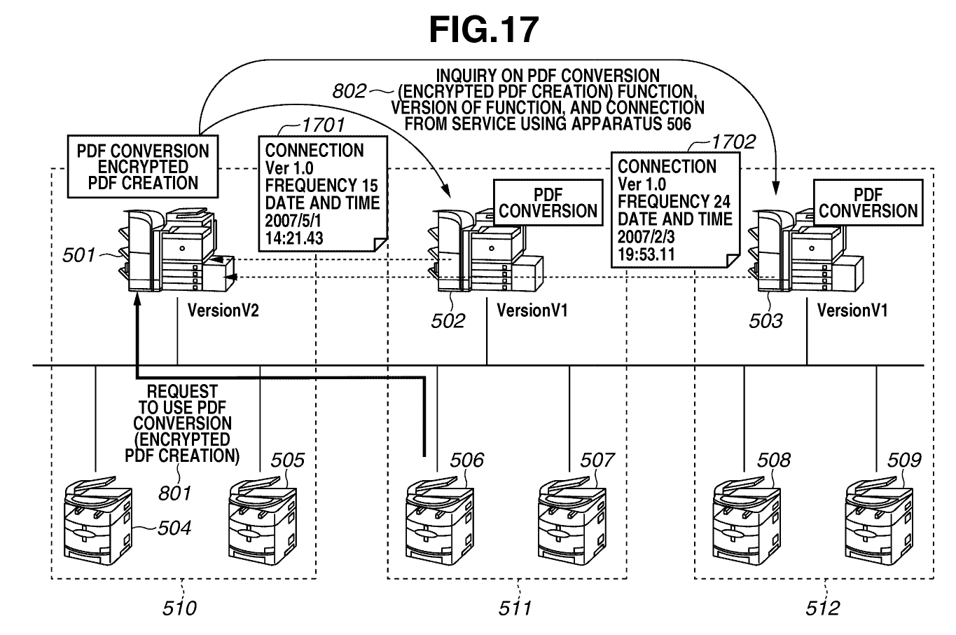

In the present exemplary embodiment, a service providing apparatus to be used is identified from the plurality of service providing apparatuses based on a version number, connection frequency, and last access date and time. In FIG. 17, same reference numerals are allocated to portions similar to FIG. 8, and description thereof is not repeated.

Referring to FIG. 17, the service providing apparatus 501 inquires the other service providing apparatuses 502 and 503 whether the service using apparatus 506 has used the service, as indicated by communication 802. The other service providing apparatuses 502 and 503 confirm connection logs of the services respectively and determine whether there has been a connection from the MAC address of the service using apparatus 506. The service providing apparatuses 502 and 503 transmit determination results to the service providing apparatus 501 which made the inquiry. More specifically, the service providing apparatuses 502 and 503 transmit identification information about a responded service providing apparatus, whether there has been a connection to the service, a version of the service, along with connection frequency (number of use) of the service and the last access date and time.

In the example illustrated in FIG. 17, the service providing apparatus 502 replies that the service providing apparatus 502 has been connected to the service using apparatus 506 with respect to the service. The service provided by the service providing apparatus 502 is the version 1.0, the connection frequency is 15 times, and the last access date and time is May 1, 2007, 14:21.43, (refer to communication 1701).

Further, the service providing apparatus 503 replies that the service providing apparatus 503 has been connected to the service using apparatus 506 with respect to the service. The service provided by the service providing apparatus 503 is the version 1.0, the connection frequency is 24 times, and the last access date and time is Feb. 3, 2007, 19:53.11 (refer to communication 1702).

In the above-described cases, the service providing apparatuses 502 and 503 both reply that the service is the version 1.0. If the service providing apparatuses provide different versions of the services, the service providing apparatus which provides a service of a higher version is selected. On the other hand, if the service providing apparatuses 502 and 503 provide services of the same version such as indicated by the communication 1701 and 1702, the service providing apparatus 501 determines a normal connection destination for the service using apparatus based on either or both of the connection frequency and the last access date and time.

For example, if the service providing apparatus is determined based on the connection frequency, the service providing apparatus 501 selects the service providing apparatus 503 whose connection frequency is 24 times as indicated in the communication 1702. If the service providing apparatus is determined based on the last access date and time, the service providing apparatus 501 selects the service providing apparatus 502 which has been most recently accessed as indicated in the communication 1701. Further, threshold values can be set on the connection frequency and the access date and time, so that the service providing apparatus whose connection frequency or the access date and time exceeds the threshold value is selected by priority.

Further, the service providing apparatus can be determined according to a value of a number of access expressed by a function in which the connection frequency and the date and time of use are weighted. An equation for acquiring the number of access can be as follows:

$$f = ( connection frequency ) \times {w}_{1} + \frac{1}{( present time ) - ( access date and time )} \times {w}_{2}$$

(where w₁ and w₂ are arbitrary weight coefficients) The present time and the access date and time can be expressed as an accumulative number of seconds counted from Jan. 1, 1970, which is a known method.

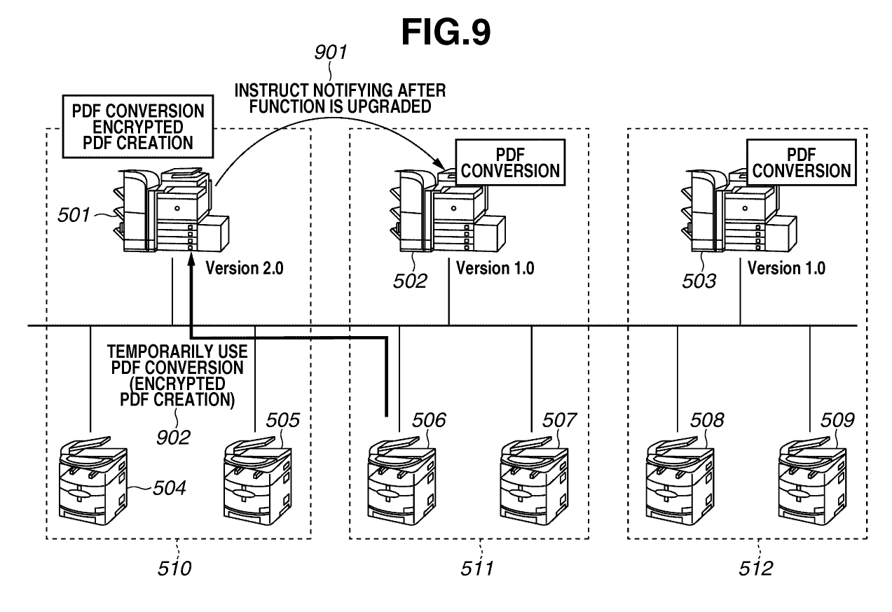

FIG. 9 illustrates a case where a service providing apparatus whose service has been previously used by a service using apparatus (referred to as a normal service providing apparatus of the service using apparatus) provides an old version of the service.

Referring to FIG. 9, the service providing apparatus 501 receives the above described communication 803 from the service providing apparatus 502 and determines that the service providing apparatus 501 and service providing apparatus 502 provide the service with different versions. More specifically, the version of functional software of the service that the service using apparatus 506 requests to the service providing apparatus 501 to provide thereto is version 2.0. On the contrary, the version of software provided by the service providing apparatus 502 that corresponds to the service requested from the service using apparatus 506 is version 1.0.

Consequently, since the version of the software of the service providing apparatus 501 is higher, the service providing apparatus 501 instructs the service providing apparatus 502 to notify the service providing apparatus 501 when the software is upgraded (refer to communication 901).

The service providing apparatus 501 allows the service using apparatus 506 to temporarily use the service thereof (refer to communication 902). The service providing apparatus 501 allows the service using apparatus 506 to use the service only temporarily. Accordingly, the service providing apparatus 501 records in the connection log of the service that the use of service is temporary, along with the identification information of the service using apparatus 506 and the date and time the service is used by the service using apparatus 506.

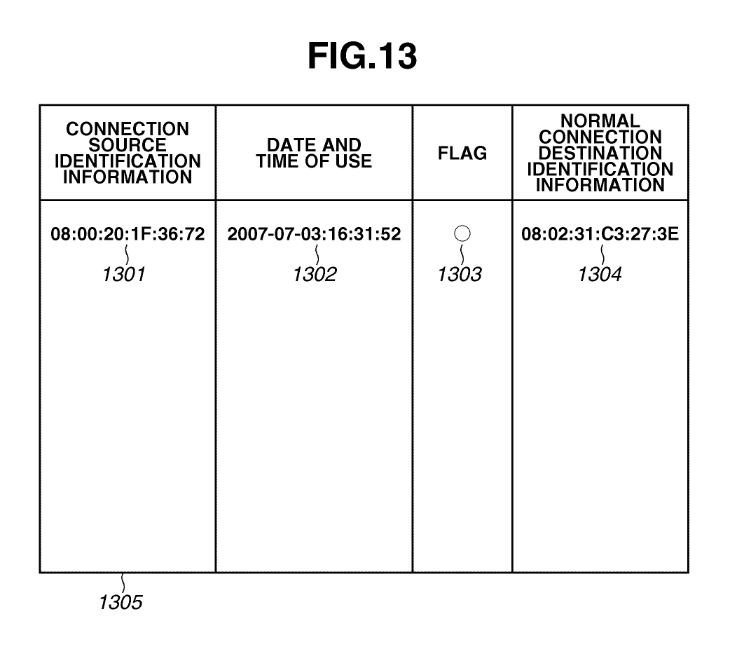

FIG. 13 illustrates an example of the connection log of the service providing apparatus 501 in the above-described case.

Referring to FIG. 13, a content 1301 indicates the connection source identification information for identifying a connection source that used the service. A content 1302 indicates the date and time the service was used. The temporary use flag becomes “on (∘)” as shown by a content 1303. A content 1304 indicates determination information about the normal service providing apparatus 502 that is normally used by the service using apparatus 506. In the example illustrated in FIG. 13, the content 1304 is a MAC address of the service providing apparatus 502.

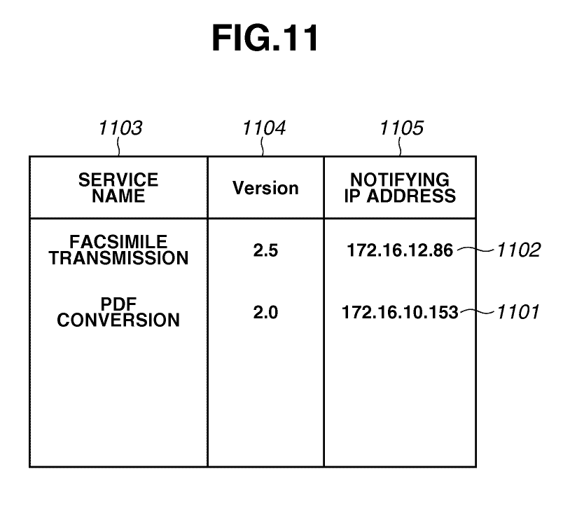

The service providing apparatus 502 manages a table illustrated in FIG. 11 for notifying the service providing apparatus 501 when the service is upgraded. More specifically, the service providing apparatus 502 manages a service name 1103 to be notified, a version 1104, and a notifying IP address 1105 of the service providing apparatus to be notified. FIG. 11 illustrates a setting 1101 and a setting 1102.

The setting 1101 indicates that the service providing apparatus 501 requests the service providing apparatus 502 to notify when the PDF conversion software is version 2.0 or above. The IP address of the service providing apparatus 501 is “172.16.10.153”. The service providing apparatus 502 thus notifies the notifying destination “172.16.10.153” when the PDF conversion software is version 2.0 or above according to the setting 1101.

Setting items are not limited to the above-described items, and any information by which a service can be uniquely identified, such as a service ID, can be used instead of the service name. Information for identifying a notifying destination can be any information as long as the notifying destination can be uniquely identified. Further, a number of the services to be notified to the service providing apparatus is not limited to one, and upgrading of versions of a plurality of services or an entire system can be notified. Further, a plurality of notifying destinations can be registered.

Further, a condition on the version number for notifying the upgrading can be set that for example, the version number of the service is the same as, greater than, or less than a designated version number. A range of the version number can also be specified. Such settings can be realized by setting a condition designation field in addition to a version number designation in the table illustrated in FIG. 11.

As described above, according to the present exemplary embodiment, there is no limitation on a procedure for notifying the service providing apparatus of version upgrading of a function in the other service providing apparatus, as long as the upgrading can be notified. In the example illustrated in FIG. 11, the condition on the version number is not designated. However, it is understood that the version number is to be the same as or greater than the designated number.

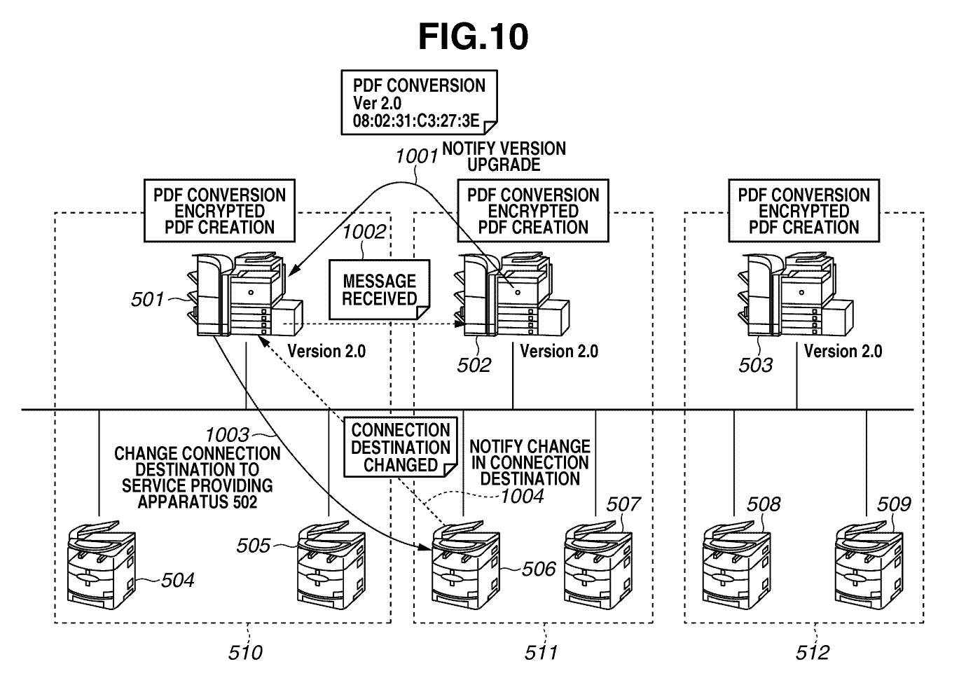

FIG. 10 illustrates an example of a process performed in a case where the version of the function of the service provided by the normal service providing apparatus is upgraded.

Referring to the communication 901 illustrated in FIG. 9, the service providing apparatus 502 is set to notify the service providing apparatus 501 when the version of the service is upgraded. Therefore, when the version of the service provided by the service providing apparatus 502 is upgraded, the service providing apparatus 502 transmits a message to the service providing apparatus 501 notifying that the version has been upgraded (i.e., communication 1001). The message includes the service name, the version number of software of the service, and information by which the message transmission source can be identified (e.g., the MAC address). Contents of the message is not limited to the above, as long as the message includes information by which the service, the version number of the software, and the message transmission source can be identified.

When the version of the software of the service is upgraded, the service providing apparatus (such as the service providing apparatus 502) refers to the notifying destination setting illustrated in FIG. 11. If the upgraded version of the service has reached the version set in the table illustrated in FIG. 11, the service providing apparatus transmits a message to the notifying destination.

For example, if the service providing apparatus 502 satisfies the condition indicated in the setting 1101 (i.e., the software of the PDF conversion is 2.0 or above), the service providing apparatus 502 transmits a message to the IP address “172.16.10.153”. The message can be transmitted using a protocol which allows message exchange. Further description on the message communication procedure will be omitted.

The service providing apparatus 501 replies to the service providing apparatus 502 that the message of the version upgrading has been received (i.e., communication 1002). The service providing apparatus 502 then deletes information about the service from the notifying destination setting illustrated in FIG. 11. In the example illustrated in FIG. 11, the setting 1101 is deleted. However, if there is no reply from the service providing apparatus 501, the service providing apparatus 502 does not delete the information about the service from the notifying destination setting. Instead, the service providing apparatus 502 repeats to transmit the message of the version upgrading at a fixed time interval. That is because the reply may not be received due to switch-off of a power, or the service providing apparatus 501 may not receive the message of the version upgrading due to a network failure.

After receiving the message of the version upgrading, the service providing apparatus 501 identifies a connection log from the service name included in the received message. The service providing apparatus 501 then searches whether identification information included in the message is included in the connection log of the service. The service providing apparatus 501 searches the connection logs whose temporary use flag is “on (∘)”. For example, the setting 1305 in the connection log illustrated in FIG. 13 matches such a search condition.

The service providing apparatus 501 then requests the service using apparatus 506 to change the connection destination for using the service (i.e., communication 1003 illustrated in FIG. 10) using the connection source identification information about the service using apparatus that used the service described in the connection log. More specifically, the service providing apparatus 501 requests the service using apparatus 506 to change the connection destination for using the service from the service providing apparatus 501 to the service providing apparatus 502.

Upon receiving the request, the service using apparatus 506 automatically changes the connection destination of the service. The service using apparatus 506 can also display a screen asking for changing the connection destination on the LCD unit 2013 illustrated in FIG. 4, so that a user can select the connection destination. More specifically, the user can temporarily use the service providing apparatus 501 and then change the connection destination to the service providing apparatus 502.

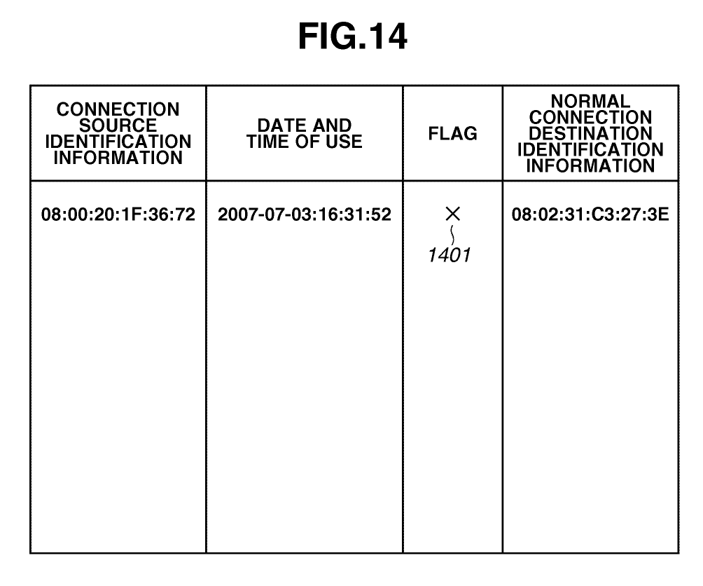

The service using apparatus 506 thus changes the connection destination for using the service and transmits a change completion notification to the service providing apparatus 501 (i.e., communication 1004). The service providing apparatus 501 then changes the temporary use flag in the connection log of the service to “connection destination changed (×)” (i.e., setting 1401 illustrated in FIG. 14). As a result, the connection log of the service will not be searched when the connection logs are searched as described above.

In the present exemplary embodiment, the MAC address is used as the identification information in the connection log, and the MAC address is converted to the IP address. However, the IP address can be used as the identification information, or the IP address can be recorded together with the MAC address.

Further, in the present exemplary embodiment, the service providing apparatus confirms the state of the temporary use flag in the connection log to identify the normal service providing apparatus and the service using apparatus that notifies of the connection destination change for using the service. However, the service providing apparatus can manage such information using a table showing correspondence relation instead of the connection log.

A case will be described below where all service providing apparatuses reply to the inquiry of the communication 802 illustrated in FIG. 8 that there has been no connection for using the service from the service using apparatus 506. In such a case, it is the first time the service using apparatus 506 uses the service which is provided by the service providing apparatus located within an accessible range via a network.

The service providing apparatus 501 allows the service using apparatus 506 to use the service thereof. The service providing apparatus 501 then records the identification information and the date and time of use of the service using apparatus 506 in the connection log of the service of the service providing apparatus 501. Unlike the example indicated by the communication 902 illustrated in FIG. 9 in which the service is temporarily used, the service is formally used. Further, since the service is not temporarily used, the flag in the connection log becomes “off (−)” similar to the setting 1205 illustrated in FIG. 12. Therefore, the identification information of the normal service providing apparatus that is to be used is not described in the connection log.

In a separate example, the service providing apparatus 502 replies to the inquiry from the service providing apparatus 501 (i.e., the communication 802 illustrated in FIG. 8) that there has been the connection from the service using apparatus 506 to use the service which is version 2.0. Further, the service providing apparatus 503 replies to the service providing apparatus 501 that there has been no connection from the service using apparatus 506 to use the service.

More specifically, the service using apparatus 506 has previously used the function of the service of the service providing apparatus 502 which provides the service of the same version as that of the service providing apparatus 501 requested by the service using apparatus 506.

Consequently, it is necessary for the service using apparatus 506 to use the service providing apparatus 502. The service providing apparatus 501 thus requests the service using apparatus 506 to change the connection destination for using the service. The service using apparatus 506 automatically changes the connection destination of the service in response to the request from the service providing apparatus 501 and transmits the change completion notification to the service providing apparatus 501.

The service using apparatus 506 can also display a screen asking for changing the connection destination on the LCD unit 2013 illustrated in FIG. 4, so that the user can select the connection destination. In other words, the user can temporarily use the service providing apparatus 501 and then change the connection destination to the service providing apparatus 502.

In the above-described example, the software version of the service providing apparatus 501 that makes the inquiry and the software version of the service providing apparatus 502 that makes the reply are the same. However, a similar process is also performed in a case where the software version of the service providing apparatus 502 is higher than that of the service providing apparatus 501.

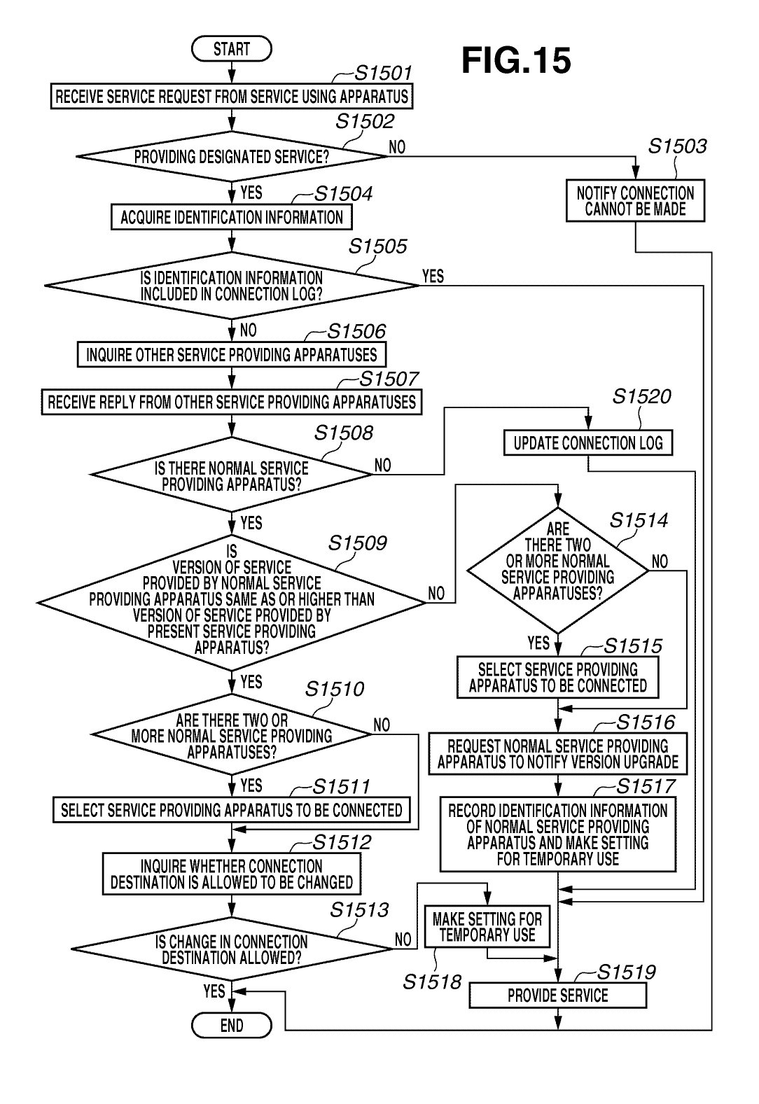

FIG. 15 is a flowchart illustrating an operation of a service providing apparatus according to the present exemplary embodiment of the present invention. The CPU 2001 included in the control unit 2000 executes a program stored in a memory to perform each step illustrated in FIG. 15.

In step S1501, the service providing apparatus receives a service request in which a predetermined service is designated from a service using apparatus.

In step S1502, the service providing apparatus determines whether the service providing apparatus is providing the service designated in step S1501. If the service providing apparatus is providing the service (YES in step S1502), the process proceeds to step S1504. On the other hand, if the service providing apparatus is not providing the service (NO in step S1502), the process proceeds to step S1503.

In step S1503, since the service providing apparatus is not providing the designated service, the service providing apparatus replies to the service using apparatus that the connection is refused. The process then ends.

In step S1504, the service providing apparatus acquires identification information for identifying the service using apparatus included in the service request received in step S1501. The identification information is an IP address or a MAC address of the service using apparatus.

In step S1505, the service providing apparatus determines whether the identification information of the service using apparatus acquired in step S1504 is included in a connection log of the service designated in step S1501. The connection log is one of connection logs managed by the service providing apparatus. If the identification information is included in the connection log (YES in step S1505), the process proceeds to step S1519. If the identification information is not included in the connection log (NO in step S1505), the process proceeds to step S1506.

In step S1506, the service providing apparatus inquires other service providing apparatuses on the network whether the service has been used by the service using apparatus identified by the identification information acquired in step S1504. More specifically, the service providing apparatus transmits information about the service designated in step S1501 and the identification information acquired in step S1504 to the other service providing apparatuses on the network.

In step S1507, the service providing apparatus receives a reply from the other service providing apparatuses to the inquiry that the service providing apparatus transmitted in step S1506. The reply from the other service providing apparatuses includes the identification information, e.g., the MAC address or the IP address, of the replying service using apparatus. The reply further includes a version of the service and whether the service providing apparatus has been connected to the service using apparatus with respect to the service. The service providing apparatus can receive the reply from the other service providing apparatuses by waiting until all service providing apparatuses have replied, or by setting a time-out of a fixed period of time.

In step S1508, the service providing apparatus confirms all of the replies received in step S1507. The service providing apparatus then determines whether there is a service providing apparatus among the other service providing apparatuses whose service has been used by the service using apparatus identified by the identification information acquired in step S1504. More specifically, the service providing apparatus determines whether there is a normal service providing apparatus of the service using apparatus identified by the identification information acquired in step S1504. If there is the normal service providing apparatus (YES in step S1508), the process proceeds to step S1509. On the other hand, if the normal service providing apparatus does not exist (NO in step S1508), the process proceeds to step S1520.

In step S1520, the service providing apparatus writes the identification information acquired in step S1504 in a connection source identification information column of the connection log managed by the service providing apparatus. Further, the service providing apparatus writes the access date and time in a corresponding column of the connection log. Further, since the service providing apparatus itself becomes the normal service providing apparatus of the service using apparatus, an “off (−)” flag is written in a temporary use flag column. The process then proceeds to step S1519.

In step S1509, the service providing apparatus determines whether the version of the service designated in step S1501, provided by the normal service providing apparatus determined in step S1508, is the same as or higher than the version of the service provided by the service providing apparatus. If the version is the same as or higher than the version of the service provided by the service providing apparatus itself (YES in step S1509), the process proceeds to step S1510. On the other hand, if the version number is lower (NO in step S1509), the process proceeds to step S1514.

In step S1510, the service providing apparatus determines whether there are two or more normal service providing apparatuses determined in step S1508. If there are two or more normal service providing apparatuses (YES in step S1510), the process proceeds to step S1511. If there is only one normal service providing apparatus (NO in step S1510), the process proceeds to step S1512.

In step S1511, the service providing apparatus selects a service providing apparatus as the connection destination, based on the version of the service, connection frequency, and last access date and time, as described above. The process then proceeds to step S1512.

In step S1512, the service providing apparatus inquires the service using apparatus whether the connection destination can be changed to the normal service providing apparatus determined in step S1508 or selected in step S1511. Since the normal service providing apparatus of the service using apparatus provides the service desired by the service using apparatus, the service providing apparatus makes such an inquiry.

In step S1513, the service providing apparatus receives a reply from the service using apparatus on the inquiry made in step S1512. If the service using apparatus has approved of changing the connection destination (YES in step S1513), the process ends. On the other hand, if the service using apparatus refuses to change the connection destination (NO in step S1513), the process proceeds to step S1518.

In step S1518, the service providing apparatus writes the identification information acquired in step S1504 and indicates that the use of service is temporary in the connection log managed by the service providing apparatus. The service providing apparatus then updates the connection log. More specifically, the service providing apparatus writes “connection destination changed (×)” in the temporary use flag column. Further, the service providing apparatus writes the identification information of the service providing apparatus that is determined in step S1508 or selected in step S1511 in the normal connection destination identification information column, and the date and time of use. In this case, a user is purposely using the service providing apparatus other than the normal service providing apparatus. Consequently, it is not necessary for the normal service providing apparatus to notify the service providing apparatus of a version upgrading.

In step S1514, the service providing apparatus determines whether there are two or more normal service providing apparatuses determined in step S1508. If there are two or more normal service providing apparatuses (YES in step S1514), the process proceeds to step S1515. On the other hand, if there is only one normal service providing apparatus (NO in step S1514), the process proceeds to step S1516.

In step S1515, the service providing apparatus selects a service providing apparatus to be connected based on the version of the service, the connection frequency, and the last access date and time, as described above. The process then proceeds to step S1516.

In step S1516, the service providing apparatus requests the normal service providing apparatus that is determined in step S1508 or selected in step S1515 to notify the service providing apparatus when the version of the service is upgraded. More specifically, the service providing apparatus transmits information about the service and the version to be notified to the normal service providing apparatus. The normal service providing apparatus which receives the request transmits a version upgrade notification to the service providing apparatus when the service is upgraded to the designated version.

In step S1517, the service providing apparatus writes the identification information acquired in step S1504 and indicates that the use of service is temporary in the connection log managed by the service providing apparatus. The service providing apparatus then updates the connection log. More specifically, the service providing apparatus sets the temporary use flag “on (∘)”. Further, the service providing apparatus writes the identification information of the service providing apparatus that is determined in step S1508 or selected in step S1515 in the normal connection destination identification information column of the connection log. Further, the service providing apparatus writes the date and time of use in the connection log.

In step S1519, the service providing apparatus provides the requested service to the service using apparatus. The process then ends.

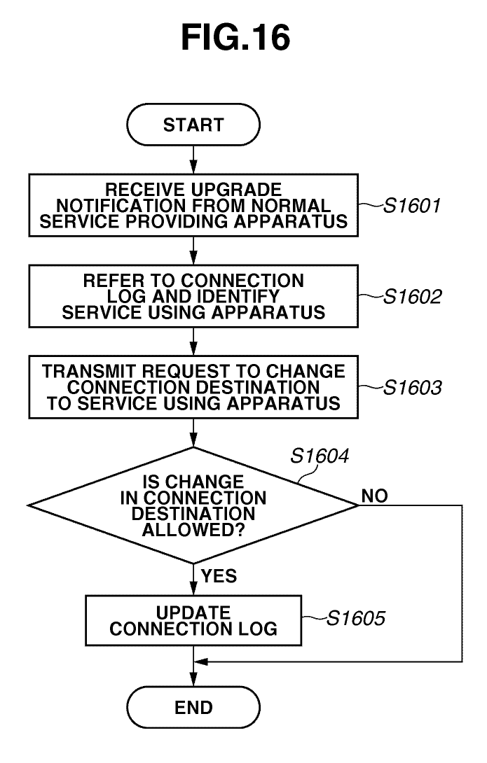

FIG. 16 is a flowchart illustrating a process performed when the service providing apparatus receives the version upgrade notification from the normal service providing apparatus of the service using apparatus. The CPU 2001 included in the control unit 2000 executes a program stored in a memory to perform each step illustrated in FIG. 16.

In step S1601, the service providing apparatus receives the version upgrade notification of the specific service from the normal service providing apparatus of the service using apparatus. The version upgrade is notified according to the registration described in step S1516 illustrated in FIG. 15.

In step S1602, the service providing apparatus refers to the connection log managed by the service providing apparatus and identifies the service using apparatus that uses the service. More specifically, the service providing apparatus identifies the service using apparatus, among the service using apparatuses whose temporary use flag is “on (∘)” in the connection log illustrated in FIG. 13, that corresponds to the connection source identification information whose transmission source of the upgrade notification in step S1601 is the normal connection destination identification information.

In step S1603, the service providing apparatus transmits a request for changing the connection destination to the service using apparatus identified in step S1602. More specifically, the service providing apparatus notifies the service using apparatus that the version of the service has been upgraded and the normal service providing apparatus that is originally used by the service using apparatus can be used.

In step S1604, the service providing apparatus determines whether the service using apparatus has allowed the change in the connection destination in response to the request transmitted in step S1603. The service providing apparatus can determine that the change is allowed when a reply to the request transmitted in step S1603 is received. Further, when the service providing apparatus transmits the request in step S1603, the service using apparatus can display a screen that asks a user to select whether to allow or not the change in the connection destination. The service providing apparatus can determine whether the change is allowed or not allowed according to a result of the selection. Further, if there is no reply from the service using apparatus after a fixed period of time elapses since transmitting the request in step S1603, the service providing apparatus can determine that the change in the connection destination is not allowed.

If the service providing apparatus determines that the change in the connection destination is allowed (YES in step S1604), the process proceeds to step S1605. In step S1605, the service providing apparatus updates the connection log managed by the service providing apparatus. More specifically, the temporary use flag which is “on (∘)” 1303 as illustrated in FIG. 13 is updated to indicate that the connection is changed, i.e., to “×” 1401 illustrated in FIG. 14.

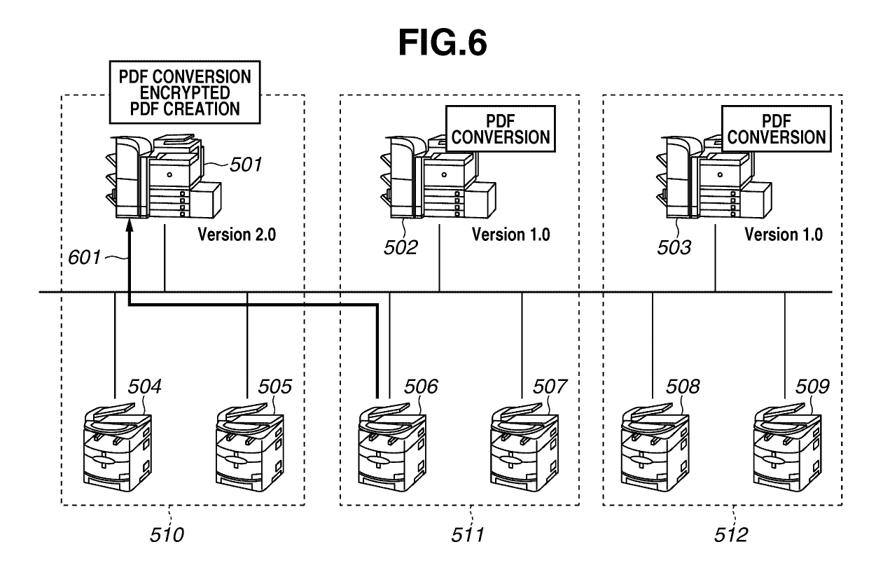

There is a case where a version of the function of the service providing apparatus that is temporarily used becomes higher. For example, in the example illustrated in FIG. 6, the version of the function of the service providing apparatus 501 is 2.0, and that of the service providing apparatus 502 is 1.0. In such a case, the service using apparatus 506 uses the function of the service providing apparatus 501 as the service in the present exemplary embodiment. Further, a table is set in the service providing apparatus 502 so that the service providing apparatus 501 is notified when the version of the service (function) in the service providing apparatus 502 is upgraded, as illustrated in the version 1104 of FIG. 11.

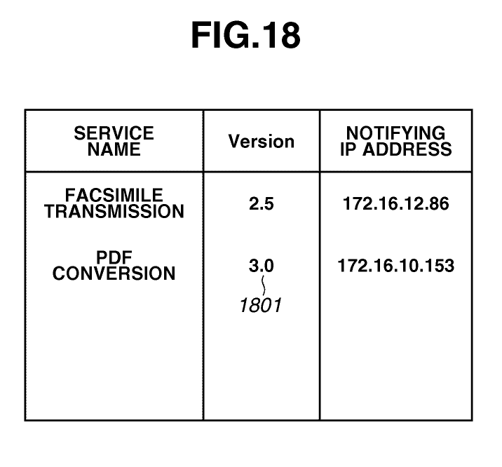

Moreover, the version of the function of the service providing apparatus 501 may become higher, such as 3.0. In such a case, the service providing apparatus 501 uses a broadcast to notify the other service providing apparatuses of the version upgrading of the service provided by the service providing apparatus 501. Upon receiving the notification, the normal service providing apparatus (i.e., the service providing apparatus 502) re-writes the table used in the version upgrade notification. For example, the service providing apparatus 502 re-writes the version as described in a setting 1801 illustrated in FIG. 18.

As described above, according to the present exemplary embodiment, the service providing apparatus can change the connection destination to the other service providing apparatus which is originally to be used by the service using apparatus, in response to the service request from the service using apparatus. Further, in a case where the version of the service requested by the service using apparatus is higher than that of the service providing apparatus that is originally to be used by the service using apparatus, the service using apparatus can temporarily use the service providing apparatus.

As a result, a use of service by the service using apparatuses is prevented from concentrating on one service providing apparatus. Further, in a case where there is a difference between functions of the service providing apparatuses, the service using apparatus can temporarily use the service providing apparatus that provides a higher function.

In the first exemplary embodiment, the service providing apparatus refers to the connection log regarding the service requested by the service using apparatus and determines whether the service has been previously used. More specifically, the service providing apparatus is not regarded as the normal service providing apparatus in a case where the service requested by the service using apparatus has not been used, even if the service using apparatus has used other services of the service providing apparatus.

A second exemplary embodiment describes a case where there is the service providing apparatus whose service other than the service requested by the service using apparatus has been used by the service using apparatus.

For example, a fee-based function is installed in only a specific service providing apparatus. In such a case, since only the specific service providing apparatus provides the function as a service, accesses from service using apparatuses concentrate on the specific service providing apparatus. However, if other service providing apparatus can provide the service, the other service providing apparatus becomes a normal service providing apparatus to which the service using apparatus can change the connection destination.

However, the service providing apparatus cannot provide the service corresponding to the function since the service providing apparatus is not described in a connection log of the service. In other words, there is no change in the connection log after the function is subsequently added to the service providing apparatus. Consequently, the connection destination cannot be changed to the service providing apparatus based on the connection log. As a result, the connection destination of the service using apparatus cannot be changed to the normal service providing apparatus. The present exemplary embodiment provides a solution to such a problem.

Configurations of a system, the service providing apparatus, and the service using apparatus according to the present exemplary embodiment are similar to that of the first exemplary embodiment. Consequently, description is not repeated.

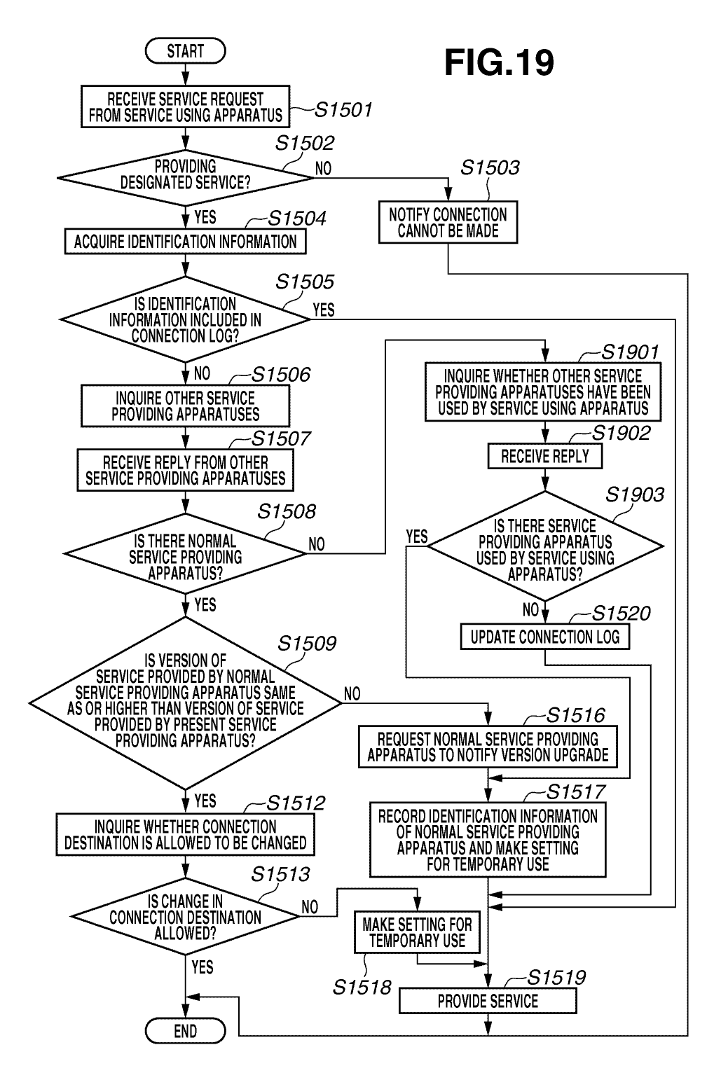

FIG. 19 is a flowchart illustrating an operation of the service providing apparatus according to the present exemplary embodiment. The CPU 2001 included in the control unit 2000 executes a program stored in the memory to perform each step illustrated in FIG. 19. Same reference numerals are allocated to portions in FIG. 19 that are similar to those in FIG. 15, therefore, description thereof is not repeated.

In step S1508 illustrated in FIG. 19, the service providing apparatus confirms all of the reply received in step S1507. The service providing apparatus then determines whether there is a service providing apparatus whose service has been used by the service using apparatus that is identified by the identification information acquired in step S1504. If there is such a service providing apparatus (YES in step S1508), the process proceeds to step S1509, similar to the first exemplary embodiment. On the other hand, if such a service providing apparatus does not exist (NO in step S1508), the process proceeds to step S1901 instead of step S1520 in the first exemplary embodiment.

In step S1901, the service providing apparatus inquires other service providing apparatuses on the network whether the service using apparatus identified by the identification information acquired in step S1504 has used any of services provided by the other service providing apparatuses. The inquiry from the service providing apparatus includes the identification information acquired in steps S1504. Each of the other service providing apparatuses receiving the inquiry then refers to connection logs of all services that it provides. The other service providing apparatuses then determine whether any of the connection logs include the identification information.

In step S1902, the service providing apparatus receives the reply to the inquiry transmitted in step S1901. The reply includes the identification information of the replying service providing apparatuses, such as the MAC address or the IP address, whether there has been a connection regarding the service, and the version of the service. The service providing apparatus can receive the reply from the other service providing apparatuses by waiting until all service providing apparatuses have replied, or by setting a time-out of a fixed period of time.

In step S1903, the service providing apparatus confirms the reply received in step S1902. The service providing apparatus then determines whether there is a service providing apparatus among the other service providing apparatuses that has been used by the service using apparatus specified in step S1504. As a result, if there is such a service providing apparatus (YES in step S1903), the process proceeds to step S1517. On the other hand, if there is no such service providing apparatus (NO in step S1903), the process proceeds to step S1520.

In step S1903, if it is determined that a plurality of service providing apparatuses has been used by the service using apparatus, the service providing apparatus to be used can be selected based on connection frequency or last access date and time. Further, a service providing apparatus in which the specific designated service has been used can be selected in preference to other service providing apparatuses. Further, a calculating formula in which a service type, the connection frequency, and the access date and time are weighted can be used to acquire a number of access. The service providing apparatus can then be selected based on the number of access.

As described above, according to the present exemplary embodiment, the service providing apparatus whose service other than the service requested by the service using apparatus has been previously used by the service using apparatus can be selected to be used by the service using apparatus.

In the first and second exemplary embodiments, the service providing apparatus notifies the normal service providing apparatus whose version of the service is lower, of the version of the service to be notified for upgrading. Further, the normal service providing apparatus manages the table illustrated in FIG. 11. Accordingly, when the service comes to show the version that is to be notified, the normal service providing apparatus notifies the service providing apparatus of the version upgrade.

In the third exemplary embodiment, the service providing apparatus notifies the normal service providing apparatus of only the service itself that the normal service providing apparatus is to notify, instead of the version of the service. The service providing apparatus which receives an upgrade notification determines whether the notified version has reached a predetermined version.

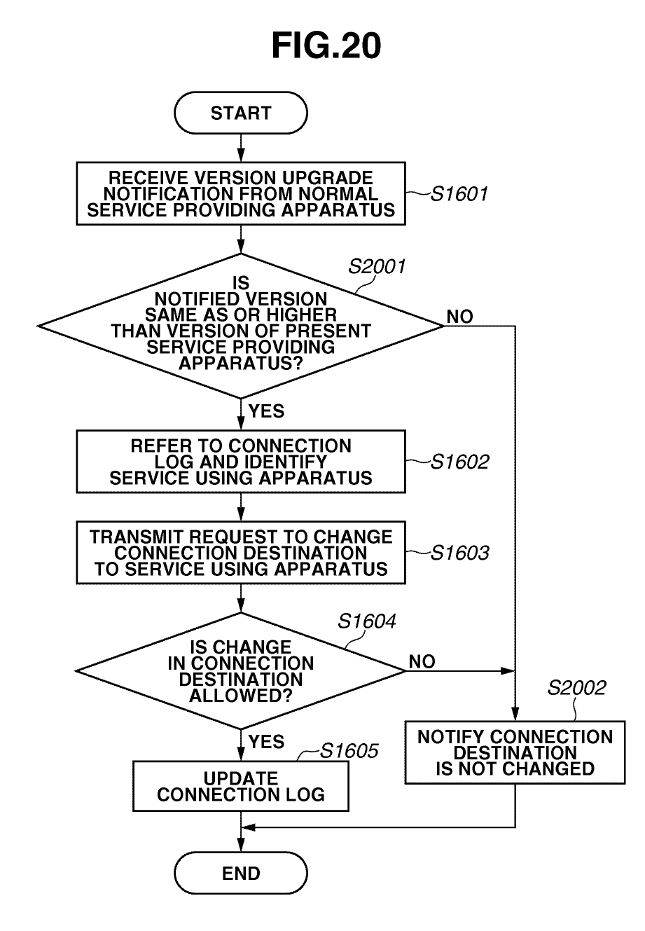

A feature of the present exemplary embodiment will be described below with reference to FIG. 20. Configurations of the system, the service providing apparatus, and the service using apparatus according to the present exemplary embodiment are similar to that of the first exemplary embodiment. Consequently, description thereof is not repeated.

FIG. 20 is a flowchart illustrating a process in a case where the service providing apparatus that received the service request from the service using apparatus receives the upgrade notification from the normal service providing apparatus. The CPU 2001 included in the control unit 2000 executes a program stored in the memory to perform each step illustrated in FIG. 20. Same reference numerals are allocated to portions in FIG. 20 that are similar to those in FIG. 16, and description thereof is not repeated.

In step S1601 illustrated in FIG. 20, the service providing apparatus receives the upgrade notification from the normal service providing apparatus. The upgrade notification includes information indicating a service and a version of the service.

In step S2001, the service providing apparatus compares the version of the service received from the normal service providing apparatus in step S1601 and the version of the service of the service providing apparatus itself. As a result, if the received version is the same or higher than the version of the service of the service providing apparatus (YES in step S2001), the process proceeds to step S1602. On the other hand, if the received version is lower than the version of the service of the service providing apparatus (NO in step S2001), the process proceeds to step S2002.

The process after step S1602 is similar to the process described in FIG. 16. In step S2002, the service providing apparatus notifies the normal service providing apparatus that the connection destination is not changed. The notification is transmitted when the version of the service of the normal service providing apparatus is lower. The notification is also transmitted when the service using apparatus does not allow a change in the connection destination, even in a case where the version of the service of the normal service providing apparatus is the same or higher. The normal service providing apparatus which receives the notification will send the upgrade notification again to the service providing apparatus when the service is upgraded.

In a case where there is a plurality of service using apparatuses in step S1602, the service providing apparatus transmits a request to change the connection destination to the plurality of service using apparatuses in step S1603.

In step S1604, the service providing apparatus waits for a reply from the service using apparatuses to which the request was transmitted. The service providing apparatus can wait for the reply from all of the service using apparatuses to which the request was transmitted, or can set a time-out and omit the service using apparatuses that have not replied. Further, the service providing apparatus can re-transmit the request to change the connection destination at a fixed time interval.

In the above-described exemplary embodiments, a service providing apparatus among a plurality of service providing apparatuses which first received a service request from a service using apparatus becomes a normal service providing apparatus of the service using apparatus. That is, if there is no other normal service providing apparatus when the service providing apparatus receives the service request from the service using apparatus, the service providing apparatus became the normal service providing apparatus.

However, the service using apparatus to be managed by the service providing apparatus can be previously registered in the service providing apparatus. More specifically, the service using apparatus to which the service providing apparatus provides the service can be previously registered in each service providing apparatus. When the service providing apparatus receives a service request from a given service using apparatus, the service providing apparatus determines whether the service using apparatus is an apparatus managed by the service providing apparatus. If the service using apparatus is not managed by the service providing apparatus, the service providing apparatus inquires other service providing apparatus whether the service using apparatus is managed by the other service providing apparatus. Further, the service providing apparatus inquires the other service providing apparatus about the version of the service that is requested by the service using apparatus.

In a case where there is a service providing apparatus that manages the service using apparatus, the service providing apparatus compares the version of the service of the service providing apparatus that manages the service using apparatus with that of the service providing apparatus itself.

In such a case, the service providing apparatus stores as data a list of the service using apparatuses managed by the service providing apparatus. The data is stored in a storage unit of the service providing apparatus, such as the ROM 2003 or the HDD 2004. The operation of the service providing apparatus in such a case is similar to the process of the flowchart illustrated in FIG. 15. The differences are as described below.

In step S1505, the service providing apparatus determines whether the identification information acquired in step S1504 is included in the list of the service using apparatuses managed by the service providing apparatus. If the identification information is included in the list, the process proceeds to step S1520. On the other hand, if the identification information is not included, the process proceeds to step S1506.

As described above, according to the present exemplary embodiment, the service using apparatuses to be managed by the service providing apparatus are registered in each service providing apparatus. As a result, group management of a system in which the service providing apparatuses and the service using apparatuses are connected can be more precisely performed.

Further, service providing apparatuses to be used by each service using apparatus can be registered in the service using apparatus. In such a case, when a service using apparatus transmits the service request to the service providing apparatus, the service using apparatus adds information indicating the registered service providing apparatus to the service request.

In the above-described exemplary embodiments, an image forming apparatus that provides its own function as a service is referred to as a “service providing apparatus”. Further an image forming apparatus that uses a service provided by the service providing apparatus is referred to as a “service using apparatus”. The service providing apparatus and the service using apparatus according to the present invention is not limited to an image forming apparatus such as a printer, a copying machine, a MFP, a scanner, or a facsimile. The service providing apparatus and the service using apparatus can be an information processing apparatus such as a server, a PC, or a mobile device.

Further, the present invention can be applied to a system configured of a plurality of devices, or an apparatus including one device.

The present invention can also be achieved by providing a storage medium which stores software (program code) for implementing functions of the above-described exemplary embodiments to a system or an apparatus. The program code stored in the storage medium can be read and executed by a computer (a central processing unit (CPU) or a micro-processing unit (MPU)) of the system or the apparatus.

In this case, the software (program code) itself realizes the functions of the above-described exemplary embodiments. The software (program code) itself and the storage medium which stores the software (program code) constitute the present invention.

The storage medium can be, for example, a floppy disk, a hard disk, an optical disk, a magneto-optical disk, a compact disc-read-only memory (CD-ROM), a CD-recordable (CD-R), a CD-rewritable (CD-RW), a digital versatile disc (DVD)-ROM, a magnetic tape, a nonvolatile memory card, or a ROM.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-300758 filed Nov. 20, 2007, which is hereby incorporated by reference herein in its entirety.

What is claimed is:

1. A service providing apparatus comprising:
a receiving unit configured to receive a service request transmitted from other apparatus;
a first determination unit configured to determine whether the other apparatus is an apparatus to be provided with a service by the service providing apparatus;
a service providing unit configured to provide the service to the other apparatus in a case where the first determination unit determines that the other apparatus is the apparatus to be provided with the service; and
a second determination unit configured to determine whether other service providing apparatus that is to provide a service to the other apparatus can provide the service in a case where the first determination unit does not determine that the other apparatus is the apparatus to be provided with the service;
wherein the service providing unit provides the service to the other apparatus in a case where the second determination unit does not determine that the other service providing apparatus can provide the service and does not provide the service to the other apparatus in a case where the second determination unit determines that the other service providing apparatus can provide the service.

2. The service providing apparatus according to claim 1, further comprising a transmission unit configured to transmit information indicating the other service providing apparatus to the other apparatus in a case where the second determination unit determines that the other service providing apparatus can provide the service.

3. The service providing apparatus according to claim 1, further comprising a third determination unit configured to determine whether there is other service providing apparatus that is to provide the service to the other apparatus in a case where the first determination unit does not determine that the other apparatus is the apparatus to be provided with the service by the service providing apparatus,
wherein the second determination unit determines whether the other service providing apparatus can provide the service to the other apparatus in a case where the third determination unit determines that there is the other service providing apparatus.

4. The service providing apparatus according to claim 1, further comprising a registration unit configured to register an apparatus to which the service providing apparatus provides the service, as an apparatus to be managed,
wherein the first determination unit determines whether the other apparatus is the apparatus to be provided with the service by the service providing apparatus by determining whether the other apparatus is registered in the registration unit.

5. The service providing apparatus according to claim 1, wherein the second determination unit determines based on information indicating a version of the service requested by the service request acquired from the other service providing apparatus.

6. The service providing apparatus according to claim 5, wherein the second determination unit determines that the other service providing apparatus cannot provide the service in a case where the version of the service acquired from the other service providing apparatus is lower than the version of the service of the service providing apparatus.

7. The service providing apparatus according to claim 6, further comprising a requesting unit configured to request the other service providing apparatus to notify when the version of the service thereof is upgraded in a case where the version of the service acquired from the other service providing apparatus is lower than the version number of the service of the service providing apparatus.

8. The service providing apparatus according to claim 1, further comprising a storage unit configured to store a log indicating that the service was previously provided to the other apparatus,
wherein the first determination unit determines whether the other apparatus is the apparatus to be provided with the service by the service providing apparatus based on the log stored in the storage unit.

9. The service providing apparatus according to claim 8, wherein the storage unit stores the log for each of a plurality of services that can be provided by the service providing apparatus.

10. The service providing apparatus according to claim 1, further comprising an inquiring unit configured to inquire the other apparatus whether the other apparatus allows changing a service providing apparatus in a case where the second determination unit determines that the other service providing apparatus can provide the service.

11. The service providing apparatus according to claim 10, wherein the service providing unit provides the service to the other apparatus in a case where the other apparatus does not allow a service providing apparatus to be changed as a result of an inquiry by the inquiring unit.

12. A method for controlling a service providing apparatus comprising:
receiving a service request transmitted from other apparatus;
determining whether the other apparatus is an apparatus to be provided with a service by the service providing apparatus;
providing the service to the other apparatus in a case where it is determined that the other apparatus is the apparatus to be provided with the service;
determining whether other service providing apparatus that is to provide a service to the other apparatus can provide the service in a case where it is not determined that the other apparatus is the apparatus to be provided with the service; and
providing the service to the other apparatus in a case where it is not determined that the other service providing apparatus can provide the service and not providing the service to the other apparatus in a case where it is determined that the other service providing apparatus can provide the service.

13. A computer-readable medium containing computer-executable instructions for controlling a service providing apparatus, the method comprising:
computer-executable instructions for receiving a service request transmitted from other apparatus;
computer-executable instructions for determining whether the other apparatus is an apparatus to be provided with a service by the service providing apparatus;
computer-executable instructions for providing the service to the other apparatus in a case where it is determined that the other apparatus is the apparatus to be provided with the service;
computer-executable instructions for determining whether other service providing apparatus that is to provide a service to the other apparatus can provide the service in a case where it is not determined that the other apparatus is the apparatus to be provided with the service; and
computer-executable instructions for providing the service to the other apparatus in a case where it is not determined that the other service providing apparatus can provide the service and not providing the service to the other apparatus in a case where it is determined that the other service providing apparatus can provide the service.
